(19) United States
(12) Patent Application Publication
(10) Pub. No.: US 2024/0378591 A1
(43) Pub. Date: Nov. 14, 2024

(54) SYSTEM AND METHOD FOR PROVIDING PROFIT DISTRIBUTION SERVICE ACCORDING TO BLOCKCHAIN-BASED ASSET INVESTMENT

(71) Applicant: Min Hyeong LEE, Seoul (KR)

(72) Inventor: Min Hyeong LEE, Seoul (KR)

(21) Appl. No.: 18/687,801

(22) PCT Filed: Oct. 25, 2021
(86) PCT No.: PCT/KR2021/015015

§ 371 Date: Feb. 28, 2024

(30) Foreign Application Priority Data
Sep. 13, 2021 (KR) 10-2021-0121560

(51) Int. Cl. G06Q 20/36; G06Q 20/12

(52) U.S. Cl. CPC G06Q 20/367; G06Q 20/1235

(57) ABSTRACT

The present invention relates to a system for providing a profit distribution service according to blockchain-based asset investment using NFT, and has an effect of providing a system and method for providing a profit distribution service according to blockchain-based asset investment, wherein an asset transaction is facilitated by issuing an asset-backed security for a live asset, such as an intellectual property right, by the system for providing a profit distribution service according to blockchain-based asset investment, the system comprising: a contract concluding unit for concluding a contract including a profit distribution structure regarding live assets, according to a request of a right holder who owns the live assets; a security issuing unit for issuing a profit-making security according to the profit distribution structure of the live assets for which the contract is concluded by the contract concluding unit; a monitoring unit for monitoring whether profits are made by the live assets for which the contract is concluded by the contract concluding unit; and a payment unit for, when the profits are made by the live assets as a result of the monitoring by the monitoring unit, paying in cryptocurrency of a same value as at least some of the profits for the security issued by the security issuing unit according to the contract concluded by the contract concluding unit.

### TECHNICAL FIELD

The present invention relates to a system for providing a profit distribution service according to blockchain-based asset investment, and more specifically, to a system for providing a profit distribution service according to blockchain-based asset investment using NFT.

### BACKGROUND ART

In general, blockchain-based transaction information cannot be arbitrarily modified. Accordingly, this enhances reliability of transactions and facilitates information tracking. Particularly in the field of financial services, efforts are ongoing to apply blockchain technology to improve work efficiency and build a new service base.

Transparent transactions through the distributed ledger system enable cost reduction for security, supervision, and regulation. Blockchain technology may be applied not only to the field, but also to logistics, distribution, and even government public administration services.

In addition, attempts for securitization of assets using the blockchain technology have been increased. The securitization of assets refers to replacing digital or spot assets and legal currency with subjects that can be traded on the network.

Various kinds of spots, such as artworks, jewelry, and even real estate, can be the subjects for the securitization of assets through distributed ledger technology. The securitized assets may be traded on the blockchain.

Therefore, there are needs for detailed and practical research on a method for securitizing assets and trading the securitized assets on the blockchain.

### RELATED ART

(Patent Document 1) KR 10-2018-0114915 A
(Patent Document 2) KR 10-2018-0113143 A
(Patent Document 3) KR 10-2018-0115764 A

### DISCLOSURE

### Technical Problem

An object of the present invention is to provide a system and a method for providing a profit distribution service according to blockchain-based asset investment to issue asset-backed securities for live assets, such as intellectual property rights, thereby facilitating asset transactions.

In addition, the present invention provides a system and a method for providing a profit distribution service according to blockchain-based asset investment to implement transactions of assets issued as digital asset-backed securities on the blockchain, so as to reduce commissions generated to existing brokers and simplify legal and administrative processing procedures required for asset transactions.

### Technical Solution

The present invention for achieving the above problems includes the following configurations.

In other words, the system for providing a profit distribution service according to blockchain-based asset investment according to one embodiment includes: a contract concluding unit for concluding a contract including a profit distribution structure regarding a profit generated from live assets at a request of a right holder who owns the live assets; a security issuing unit for issuing a profit-making security according to the profit distribution structure regarding the live assets for which the contract is concluded by the contract concluding unit; a monitoring unit for monitoring whether profits are generated from the live assets for which the contract is concluded by the contract concluding unit; and a payment unit for paying in cryptocurrency of a same value as at least some of the profits for the security issued by the security issuing unit according to the contract concluded by the contract concluding unit when the profits are generated from the live assets during the monitoring by the monitoring unit.

Meanwhile, the method for providing a profit distribution service according to blockchain-based asset investment, which is executed by the system for providing the profit distribution service according to the blockchain-based asset investment, includes the steps of: concluding a contract including a profit distribution structure regarding live assets, according to a request of a right holder who owns the live assets; issuing a profit-making security according to the profit distribution structure regarding the contract-concluded live assets; monitoring whether profits are generated from the contract-concluded live assets; and paying in cryptocurrency of a value equivalent to at least some of the profits for the issued security according to the concluded contract when the profits are generated from the live assets during the monitoring.

### Advantageous Effects

According to the system and the method for providing a profit distribution service according to blockchain-based asset investment, asset-backed securities for live assets, such as intellectual property rights, are issued, so that asset transactions can be facilitated.

In addition, according to the system and the method for providing a profit distribution service according to blockchain-based asset investment, transactions of assets issued as digital asset-backed securities on the blockchain are implemented, so that commissions generated to existing brokers can be reduced and legal and administrative processing procedures required for asset transactions can be simplified.

In addition, the system and the method for providing a asset investment may solve the problem that values of existing blockchain profit-making securities may disappear depending on the existence of blockchain issuers or exchanges, so that investors can request profit distribution on NFT from asset owners based tokens even when intermediaries such as the blockchain issuers or exchanges disappear and credibility and fundamental values can be given to the blockchain profit-making securities using NFT.

### DESCRIPTION OF DRAWINGS

FIG. 1 is an exemplary diagram for describing an operation of a profit sharing service providing system according to one embodiment of the present invention.

FIG. 2 is a block diagram of a system for providing a profit distribution service according to blockchain-based asset investment according to one embodiment of the present invention.

FIG. 3 is a flowchart of a method for providing a profit distribution service according to blockchain-based asset investment according to one embodiment of the present invention.

### BEST MODE

### Mode for Invention

It will be noted that technical terms used in the present invention are used only to describe specific embodiments, and are not intended to limit the present invention. In addition, the technical terms used in the present invention will be interpreted as meanings generally understood by a person having ordinary skill in the art, unless specifically defined as other meanings in the present invention, and will not be interpreted as excessively comprehensive meanings or excessively reduced meanings.

Hereinafter, exemplary embodiments according to the present invention will be described in detail with reference to the accompanying drawings.

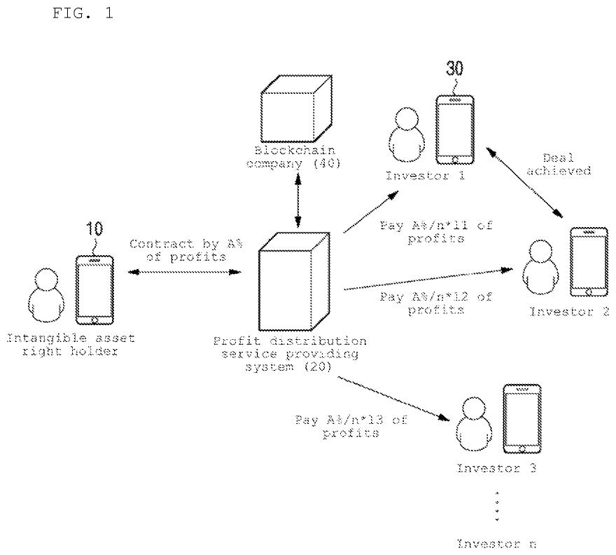

FIG. 1 is an exemplary diagram for describing an operation of a profit sharing service providing system according to one embodiment of the present invention.

The profit distribution service providing system 20 according to one embodiment of the present invention provides a service platform in the form of an NET profit-making security exchange operated by a blockchain company.

First, the profit distribution service providing system 20 concludes a contract between a blockchain company 40 and a right holder who owns an asset such as a patent to grant the blockchain company 40 an authority to issue and trade A % of a profit generated from the patent of the live asset right holder as NFT-type profit-making securities.

At this timing, the contract between the live asset right holder and the blockchain company 40 may include contents such as an authority of authorizing the blockchain company to monitor generation of profits from the patent subject to the contract to collect for the issuance of securities by A that is the amount of securities concluded as the contract, an authority to convert the collected profits into cryptocurrency and distribute the converted cryptocurrency to wallets for owned NFTs, and a required consent by the blockchain company 40 for the disposal of the asset by the asset right holder.

The blockchain company 40 may issue n NFTs as profit-making securities, which are issued under a contract concluded with the live asset right holder, to a plurality of investors (Investor 1, Investor 2, Investor 3, . . . , and Investor m).

The blockchain company 40 collects a predetermined percentage of the profits generated through the subject asset according to the contract with the asset right holder. The blockchain company 40 may convert the collected profits into cryptocurrency via the cryptocurrency exchange or the like and then pay cryptocurrency (share profits) at a rate corresponding to the number of NFTs to a wallet address that owns the NFTs at the corresponding time.

Specifically, the profit distribution service providing system 20 pays, to Investor 1, an amount equivalent to the number of issued profit-making securities I1, which Investor 1 has wanted to purchase, among the A %/n of the profits from the blockchain company 40.

In addition, an amount equivalent to the number of issued profit-making securities I2, which Investor 2 has wanted to purchase, among the A %/n of the profits from the blockchain company 40 is paid to Investor 2, and an amount equivalent to the number of issued profit-making securities I3, which Investor 3 has wanted to purchase, among the A %/n of the profits from the blockchain company 40 is paid to Investor 3.

In addition, when the blockchain company 40 sells NFTs as set price to a plurality of investors (Investor 1, Investor 2, . . . , and Investor n) on an NET profit-making securities exchange, the profit sharing service providing system 20 according to one embodiment may provide the original right holder, who is the live asset provider, with an amount after subtracting the commission of the blockchain company 40 from the profits obtained by selling the NFTs via the NET profit-making securities exchange.

In other words, the profit sharing service providing system 20 according to one embodiment may implement a profit-creating structure in which a right holder of a profit-making asset, such as an intellectual property right including a patent, entrusts the profit-making asset to the blockchain company 40 to sell a portion of profits generated from the asset in the form of an NFT and then receives proceeds from sale.

In addition, a purchaser having purchased the NFT issued by the blockchain company 40 based on the contract with the right holder, that is, an investor may sell the NFT to another purchaser, that is, another investor via the NFT profit-making securities exchange provided by the profit sharing service providing system 20.

At this time, a royalty function on an NFT is implemented so that a predetermined amount may be paid to the blockchain company 40 as a token issuer. Accordingly, a structure capable of NFT transactions and transaction commission payments on the blockchain without a separate HTS system can be provided.

The system 20 for providing a profit distribution service according to blockchain-based asset investment according to one embodiment of the present invention stores various types of digital files (metadata) including profit-making securities in a distributed storage system such as ipfs, and links the digital files through token URIs of NFTs. Accordingly, non-fungible is possible.

In other words, the system 20 for providing a profit distribution service according to blockchain-based asset investment according to the one embodiment may include a legally effective contract pdf (a contract signed between an owner of a live asset and a blockchain issuer) as metadata, so as to enable an investor (NFT owner) to claim a profit dividend right on the live asset.

Accordingly, an investor's act of purchasing the NFT profit-making securities includes a kind of smart contract concept that is the same as the act of reviewing/signing the contract contents in practice, notarizing (for transparency of the blockchain), and sharing the contract between the contracting parties.

The existing blockchain profit-making securities have a problem in that values thereof may disappear depending on the existence of blockchain issuers or exchanges.

Since the system 20 for providing a profit distribution service according to the one embodiment includes the kind of smart contract concept that is the same as the act of sharing a contract between contracting while ensuring transparency of the blockchain in the process of reviewing, signing and notarizing the contents of the contract, the investor owning the NFT according to one embodiment may request distribution of profits to the live asset right holder based on the NET token even when intermediaries such as the blockchain issuers or exchanges disappear.

Accordingly, the blockchain profit-making securities using NFTs according to one embodiment may be given reliability and fundamental values.

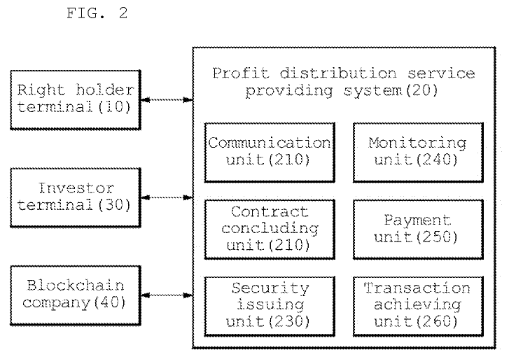

FIG. 2 is a block diagram of a system for providing a asset investment according to one embodiment of the present invention.

As shown in FIG. 2, the system 20 for providing a profit distribution service according to blockchain-based asset investment according to one embodiment includes a communication unit 210, a contract concluding unit 220, a security issuing unit 230, a monitoring unit 240, a payment unit 250, and a transaction achieving unit 260.

The communication unit 210 communicatively connects a predetermined internal component to at least one predetermined external terminal through a wired/wireless communication network. The predetermined external terminal may include a right holder terminal 10, an investor terminal 30, a blockchain company server, and the like. Examples of wireless Internet technologies include Wireless LAN (WLAN), Digital Living Network Alliance (DLNA), Wireless Broadband (Wibro), World Interoperability for Microwave Access (Wimax), High Speed Downlink Packet Access (HSDPA), High Speed Uplink Packet Access (HSUPA), IEEE 802.16, Long Term Evolution (LTE), Long Term Evolution-Advanced (LTE-A), and Wireless Mobile Service Broadband (WMBS), and the communication unit 210 transmits and receives data according to at least one wireless Internet technology in a range including Internet technologies that are not listed above. In addition, the short-range communication technology may include Bluetooth, radio frequency identification (RFID), Infrared data association (IrDA), ultra wideband (UWB), ZigBee, near communication (NFC), ultra sound field communication (USC), visible light communication (VLC), and Wi-Fi, Wi-Fi Direct. In addition, the wired communication technology may include power line communication (PLC), USB communication, Ethernet, serial communication, and optical/coaxial cable.

The right holder terminal 10, the investor terminal 30, and the blockchain company server may be applied to various terminals such as a smart phone, a portable terminal, a mobile terminal, a foldable terminal, a personal Digital assistant (PDA), a portable multimedia player (PMP) terminal, a telematics terminal, a navigation terminal, a personal computer, a notebook computer, a slate PC, a tablet PC, an ultrabook, a wearable device (including, for example, a smartwatch, a glass-type terminal, a head mounted display (HMD) and the like), a Wibro terminal, a protocol television (IPTV) terminal, a smart TV, a digital broadcasting terminal, an audio/video navigation (AVN) terminal, an audio/video (A/V) system, a flexible terminal, and a digital signage device.

In one embodiment, the right holder terminal 10 is implemented as a terminal device possessed by a right holder who owns various types of profit-making assets including intellectual property such as a patent, a utility model, or a design.

The investor terminal 30 is implemented as a terminal device possessed by an investor who wants to invest in profits generated by the asset through the NET profit-making securities exchange provided by the profit sharing service providing system according to the embodiment.

The contract concluding unit 220 concludes a contract including a profit distribution structure for a live asset between a right holder and a blockchain company at a request of the right holder who owns the live asset. The live asset is interpreted to cover all profitable assets including rights such as patent, utility model and design rights.

In one embodiment, the contract concluding unit 220 concludes a contract between the right holder terminal 10 possessed by a right holder who owns an asset such as a patent, and the blockchain company 40 that issues a profit-making security for a predetermined percentage of profits generated from the patent.

The contract concluded by the contract concluding unit 220 includes a function of granting the blockchain company 40 an authority to trade for 20% of the profits generated from the patent owned by the right holder.

In addition, the contract includes, for example, an authority of authorizing the blockchain company 40 to collect some of the profits within a range of the granted authority, a function of granting an authority to convert the collected profits into cryptocurrency and distribute the cryptocurrency to at least one or more investors who own NFTs, and a content that a consent by the blockchain company 40 is required for the disposal of the patent by the asset right holder.

In one aspect of the present invention, the contract concluding unit 220 groups at least two live assets into a portfolio and recognizes the portfolio as live assets. For example, when the live asset is a patent, a contract with respect to a patent to be invested may be concluded not only for a single patent but also for multiple patents formed by combining several patents in the form of a portfolio.

The security issuing unit 230 issues profit-making securities according to the profit distribution structure for the live assets contracted by the contract concluding unit 220. The security issuing unit 230 issues digital asset backed securities (DABS) for the asset.

In a feature aspect of the present invention, the security issuing unit 230 issues non-fungible token (NFT) profit-making securities according to the profit distribution structure.

The non-fungible token (NFT) exists only as one unique NFT even in a basic concept. However, in one embodiment, the security issuing unit 230 may apply a concept of copy to create NFTs having the same characteristics into n copies.

According to this aspect, n NFTs issued by the blockchain company 40 may be sold to a plurality of investors.

In one embodiment, the NFT includes a copy function capable of issuing a plurality of NFTs having the same characteristics when issuing the NFT, and a royalty function capable of transmitting a predetermined percentage of a transaction payment to a token issuer wallet address when trading the NFT.

For example, the security issuing unit 230 may issue a specific patent (=P1) as 50 copies. The security issuing unit 230 may issue P1-NFT profit-making securities corresponding to 20% of profits generated by a patent (P1) specified based on the contract concluded by the contract concluding unit 220. For example, when P1-NFT is issued in 50 copies, each P1-NFT profit-making security has a right corresponding to 20%×2% (=1/50) of a profit accrual of the Patent P1.

In one embodiment, the NFT copy function may allow a desired quantity of items to be transmitted to multiple recipients through one transaction. In one embodiment, since all of transfer, approve, melting, and trade functions use arrays as parameters, 100 to 200 operations may be performed in a single transaction.

Accordingly, the security issuing unit 230 of the system 20 for providing a profit distribution service according to blockchain-based asset investment according to one embodiment may issue a plurality of profit-making securities by issuing, as a copy, securities for an asset right to at least two investors based on investment ratios set for the investors, respectively.

In one embodiment, an expiration time point of the NFT profit-making security may be when the right of the subject asset, such as a patent, itself is expired, or when the right holder having concluded the contract in the contract concluding unit 220 is changed through the sale of the patent or the like.

In one aspect of the present invention, the security issuing unit 230 issues profit-making securities to at least two investors based on investment ratios set the investors, respectively.

In one embodiment, the security issuing unit 230 may issue the profit-making securities in response to the investor's request of purchasing the profit-making securities and pay the profit-making securities to the investor's wallet. The security issuing unit 230 stores a JSON file including rights information of the corresponding profit-making security and the contract for claiming the right to distribute profits in a distributed storage system, and links the file to a token address through the URI of the non-fungible token (NFT).

The system 20 for providing a profit distribution service according to blockchain-based asset investment according to one embodiment of the present invention stores various types of digital files (metadata) including profit-making securities in the distributed storage system, such as a ipfs, and links the digital files through token URIs of NFTs. Accordingly, non-fungible is possible.

In other words, the system 20 for providing a profit distribution service according to blockchain-based asset investment according to one embodiment of the present invention may include a legally effective contract pdf (a contract signed between an owner of a live asset and a blockchain issuer) as metadata, so as to enable an investor (NFT owner) to claim a profit dividend right on the live asset.

Accordingly, an investor's act of purchasing the NFT profit-making securities includes a kind of smart contract concept that is the same as the act of reviewing/signing the contract contents in practice, notarizing (for transparency of the blockchain), and sharing the contract between the contracting parties.

According to one embodiment, even when the intermediates such as the blockchain issuers or the exchanges disappear, the NFT owner may request the live asset right holder to distribute profits based on the NFT token, and accordingly, the blockchain profit-making security using the NFT according to the one embodiment may be given credibility and fundamental value.

The monitoring unit 240 monitors whether profits are generated from the live asset contracted by the contract concluding unit 220.

For example, when the live asset is a patent, profits generated from the patent include a patent usage commission profit, a profit generated through litigation, and a profit generated through sales. The monitoring unit 240 is implemented to monitor a profit-creation state of the right holder based on the contract concluded by the contract concluding unit.

For example, when an asset is a patent, the monitoring unit may be implemented to monitor whether sales occur to a partner having agreed to use a corresponding technology or check an amount agreed to be paid as the usage amount of patent royalties among sales by checking the generated sales amount.

Alternatively, the monitoring unit 240 may be implemented to monitor whether a license fee has occurred and an amount of the license fee by checking whether a product on which a license is set for the patent as the live asset has been sold and the sales amount.

Alternatively, for example, when the asset is a sound source, it may be implemented to monitor copyright fees and the like generated according to the use of the sound source by the right holder in conjunction with the copyright association. However, the present invention is not limited thereto.

When the profit is generated by the live asset as a result of the monitoring by the monitoring unit 240, the payment unit 250 pays in cryptocurrency having a value equivalent to at least a portion of the profit with respect to the securities issued by the security issuing unit 230 based on the contract concluded by the contract concluding unit 220.

In one aspect, the payment unit 250 may pay cryptocurrency at a rate corresponding to the number of NFTs among the profits generated by the live asset to a wallet address that owns the NFTs for each investor.

In one aspect, the payment unit 250 pays in the cryptocurrency among the profits generated by the live assets to the investor wallet based on the profit-making securities issued for each investor.

For example, the blockchain company 40 converts the collected profits into cryptocurrency such as Ethereum via a cryptocurrency exchange or the like, and then pays in cryptocurrency of a value corresponding to the dividend amount of the profits at a rate corresponding to the number of NFTs owned by the wallet address of the investor owning the NFT at a corresponding time.

The payment unit 250 may further provide the original right holder who is a live asset provider with an amount excluding a commission of the blockchain company among the profits obtained by selling the NFT through the NET profit-making securities exchange provided by the profit distribution service providing system 20.

In another aspect of the present invention, the payment unit 250 may collect a predetermined amount of the profits generated through the subject asset from the right holder according to the contract concluded between the blockchain company 40 and the right holder in the contract concluding unit 220.

In another aspect of the present invention, the transaction achieving unit 260 of the profit distribution service providing system 20 according to one embodiment achieves the transaction of the profit-making securities between the investors having received the issued profit-making securities for the profit generated by the live assets.

In one embodiment, an investor's act of purchasing the NET profit-making securities includes a kind of smart contract concept that is the same as the act, in practice, of sharing the contract between the contracting parties through a series of reviewing, signing and notarizing contents of the contract. The series of processes of reviewing, signing, and notarizing the contents of the contract may be carried out by transparency through the blockchain.

In addition, the investor having purchased the NFT from the blockchain company 40 having issued the beneficiary securities in the form of NFT may sell the NFT to another prospective buyer thereafter. The transaction achieving unit 260 may perform a procedure required for achieving a transaction between a (selling) investor having purchased the NFT first and a (buying) investor wanting to purchase the NFT.

In a trading transaction between investors, the NFT stored in the (selling) investor's wallet is moved to the (buying) investor's wallet, and the (buying) investor is required to pay the (selling) investor using money the same as a value of the profit-making securities in the form of NFT. The payment means may be implemented in various forms, such as cryptocurrency payment or Korean won payment.

In one embodiment, the transaction achieving unit 260 may process loyalty function of NFT, such that a predetermined amount is paid to the blockchain company 40 as a token issuer when the transaction between investors is achieved.

In other words, the kind of smart contract concept the same as the act of sharing the contract between investors and contracting parties is included in metadata of the NFT, a structure may be provided in which NFT transactions between investors and transaction commission payments are allowed on the blockchain without a separate HTS system.

In an additional aspect of the present invention, the transaction achieving unit 260 may objectively evaluate a value of an intellectual property (IP) as an asset owned by the investor, that is, profit-making securities, and calculate an expected profit. In addition, the transaction achieving unit may calculate a market price (asking price) for the beneficiary securities of the asset based on the calculated expected profit, and achieve the transaction between investors at the calculated market price.

In one embodiment, the transaction achieving unit 260 may provide its own market platform to provide a transaction function between investors. Specifically, it may be implemented to display a asking price and a quantity of at least one type of profit-making security in the form of NFT through the market platform and select a profit-making security desired to be purchased by an investor on the market platform to achieve transaction between investors. Accordingly, a market platform capable of more conveniently carrying out transactions of NFT copies may be further provided in addition to the existing platform focusing on only one NFT transaction.

For example, the transaction achieving unit 260 is implemented to enable only for the investor having logged in after registering and setting a personal wallet through the market platform according to the exemplary embodiment to perform a transaction with another investor.

In one embodiment, a JSON file of a corresponding token is stored in a token address of the NFT. The JSON is an open standard format that uses text to convey a data object composed of attribute-value pairs and array data types (or any other serviceable value) or key-value pairs.

For example, the JSON file may be stored in an NFT token address and NFT's token URI includes a name of NFT, a name of blockchain issuing company (issuer), a name of intellectual property (IP) right holder, the share ratio of intellectual property (ratio of rights held by one NFT), that is, the dividend ratio among the profits generated from a subject asset, URL information (i.e., ipfs and doi) in which a PDF file of a copy of the contract concluded between the right holder and the blockchain issuer is stored, URL information (i.e., ipfs) in which an image containing right information of the corresponding beneficiary security is stored, the number of patents in a portfolio when multiple patents are grouped in the portfolio, a registration number for each patent included in the portfolio, and other main contract conditions of the profit-making securities.

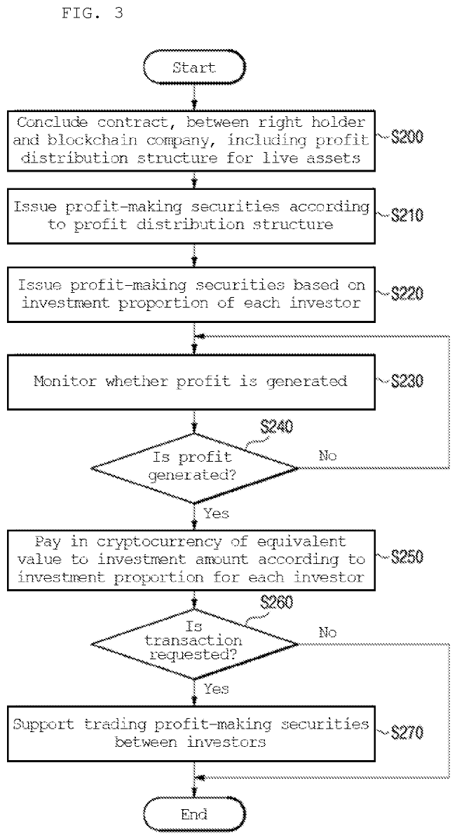

FIG. 3 is a flowchart of a method for providing a profit distribution service according to blockchain-based asset investment according to one embodiment of the present invention.

A method for providing a profit distribution service according to blockchain-based asset investment, which is executed by the system for providing the profit distribution service according to the blockchain-based asset investment according to one embodiment, concludes a contract including a profit distribution structure for a live asset with a blockchain company at a request of a right holder owning the live asset (S200).

The live asset is interpreted to cover all profitable assets including rights such as patent, utility model and design rights.

In one embodiment, the step of concluding the contract includes concluding a contract between a right holder terminal held by a right holder who owns a patent and a blockchain company issuing a profit-making security for a predetermined percentage of the profit generated from the patent.

The contract concluded by the contract concluding unit includes a function of granting the blockchain company an authority to trade for 20% of profits generated by the patent owned by the right holder.

In addition, the contract includes, for example, an authority of authorizing the blockchain company to collect some of the profits within a range of the granted authority, a function of granting an authority to convert the collected profits into cryptocurrency and distribute the cryptocurrency to at least one or more investors who own NFTs, and a content that a consent by the blockchain company is required for the disposal of the patent by the right holder.

In one aspect of the present invention, in the step of concluding a contract, at least two live assets are grouped in a portfolio and recognized as live assets. For example, when the live asset is a patent, a contract with respect to the subject patent may be concluded not only for a single patent but also for multiple patents formed by combining several patents in the form of a portfolio.

Then, profit-making securities are issued according to the profit distribution structure for the contracted live assets (S210).

In the step of issuing the securities, profit-making securities are issued to at least one investor based on the invested ratio set for each investor.

The step of issuing the securities includes issuing a digital asset backed securities (DABS) for the asset.

In one aspect, the step of issuing the securities may include issuing non-fungible token (NFT) profit-making securities according to a profit distribution structure.

The non-fungible token (NFT) exists only as one unique NFT even in a basic concept. However, in one embodiment, the step of issuing the securities may include applying a concept of copy to create NFTs having the same characteristics into n copies.

In one embodiment, the NFT includes a copy function capable of issuing a plurality of NFTs having the same characteristics when issuing the NFT, and a royalty function capable of transmitting a predetermined percentage of a transaction payment to a token issuer wallet address when trading the NFT.

According to the above aspect, the n NFTs issued by the blockchain company may be sold to a plurality of investors.

For example, in the step of issuing securities, a specific patent (=P1) may be issued in 50 copies. In the step of issuing the securities, P1-NFT profit-making securities corresponding to 20% of profits generated by the patent (P1) specified based on the concluded contract may be issued. For example, when P1-NFT is issued in 50 copies, each P1-NFT profit-making security has a right corresponding to 20%×2% (=1/50) of a profit accrual of the Patent P1.

In one embodiment, an expiration time point of the NFT profit-making security may be when the right of the subject asset, such as a patent, itself is expired, or when the right holder having concluded the contract is changed through the sale of the patent or the like.

Thereafter, monitoring is performed on whether a profit is generated from the contracted live asset (S230).

For example, when the live asset is a patent, the profit generated from the patent include a patent usage fee profit, a profit generated through litigation, and a profit generated through sale. The step of monitoring is implemented to monitor a profit-creation status of the right holder based on the concluded contract.

As a result of the monitoring, when the profit is generated from the live asset (S240), cryptocurrency having a value equivalent to at least a portion of the profit is paid to the issued securities according to the concluded contract (S250).

In one aspect of the present invention, the payment step includes paying the cryptocurrency to the investor wallet based on the profit-making security issued for each investor among the profits generated from the live asset.

The cryptocurrency is paid at a rate equivalent to the number of NFTs stored in the wallet address that owns the NFTs for each investor among the profits generated from the live asset.

Thereafter, when there is a transaction request between investors (S260), trading the profit-making securities between the investors may be supported (S270).

In other words, an investor having purchased NFT from having issued profit-making the blockchain company securities in the form of NFT may sell the NFT to another prospective buyer afterward. A necessary procedure may be performed to achieve a trading transaction between a first (selling) investor having purchased the NFT and a (buying) investor who wants to purchase the NFT. Due to a loyalty function of NFT, a predetermined amount may be paid to the blockchain company as a token issuer when the transaction between investors is achieved.

In other words, a structure may be provided in which NFT transactions and transaction commission payments are allowed on the blockchain without a separate HTS system.

The above-described method may be implemented in the form of program instructions, which may be implemented as an application or executed through various computer components, and recorded in a computer-readable recording medium. The computer-readable m may include program instructions, data files, data structures, and the like alone or in combination.

The program instructions recorded in the computer-readable recording medium may be specially designed and configured for the present invention, and may be well-known and available to those skilled in the field of computer software.

Examples of the computer-readable recording medium include a magnetic medium such as a hard disk, a floppy disk, and a magnetic tape, an optical recording medium such as a CD-ROM and a DVD, a magneto-optical medium such as a floptical disk, and a hardware device, such as a ROM, a RAM and a flash memory, specially configured to store and execute program instructions.

Examples of the program instructions include not only machine language codes made by a compiler, but also high-level language codes executable by a computer using an interpreter or the like. The hardware device may be configured to operate as one or more software modules to perform the processing according to the present invention, and vice versa.

Although the above description has been made with reference to the embodiments, it will be understood by those skilled in the art that the present invention may be variously modified and changed without departing from the spirit and scope of the present invention described in the following claims.

### DESCRIPTION OF REFERENCE NUMERALS

10: Right holder terminal 20: Profit distribution
service providing system
30: Investor terminal 40: Blockchain company
210: Communication unit 220: Contract concluding unit
230: security issuing unit 240: Monitoring unit
250: Payment unit 260: Transaction achieving unit

1. A system for providing a profit distribution service according to blockchain-based asset investment, the system comprising:
a contract concluding unit for concluding a contract including a profit distribution structure for profits generated from a live asset at a request of a right holder owning the live asset;
a security issuing unit for issuing profit-making securities according to the profit distribution structure for the live asset concluded by the contract concluding unit;
a monitoring unit for monitoring whether a profit is generated from the live asset contract-concluded by the contract concluding unit;
a payment unit for paying in cryptocurrency of a value equivalent to at least portion of the profit for the security issued by the security issuing unit according to the contract concluded by the contract concluding unit when the profits are generated from the live asset during the monitoring by the monitoring unit.

2. The system of claim 1, wherein the security issuing unit issues non-fungible token (NFT) profit-making securities according to the profit distribution structure.

3. The system of claim 2, wherein the security issuing unit stores a JSON file including rights information of a corresponding profit-making security and a contract for claiming a profit distribution right in a distributed storage system, and links the file to a token address through URI of the NFT.

4. The system of claim 1, wherein the contract concluding unit groups at least two live assets into a portfolio and recognizes the portfolio as live assets.

5. The system of claim 2, wherein the security issuing unit issues a profit-making security to at least one investor based on an investment proportion set each investor, and the payment unit pays in cryptocurrency to a wallet of the investor based on the profit-making security issued for each investor among the profits generated from the asset.

6. The system of claim 5, wherein the payment unit pays in the cryptocurrency at a ratio corresponding to a number of NFTs stored in a wallet address owning the NFTs for each investor among the profits generated from the live asset.

7. A method for providing a profit distribution service according to blockchain-based asset investment, which is executed by the system for providing the profit distribution service according to the blockchain-based asset investment, the method comprising:
concluding a contract including a profit distribution structure regarding profits generated from live assets at a request of a right holder owning the live assets;
issuing a profit-making security according to the profit distribution structure regarding the contract-concluded live assets;
monitoring whether profits are generated from the contract-concluded live assets; and
paying in cryptocurrency of a value equivalent to at least a portion of the profits for the issued security according to the concluded contract when the profits are generated from the live assets during the monitoring.

8. The method of claim 7, wherein the issuing of the security includes issuing a non-fungible token (NFT) profit-making security according: distribution structure.

9. The method of claim 8, wherein the issuing of the security includes storing a JSON file including rights information of a corresponding profit-making security and a contract for claiming a profit distribution right in a distributed storage system, and linking the file to a token address through URI of the NFT.

10. The method of claim 7, wherein the concluding of the contract includes grouping at least two live assets into a portfolio and recognizing the portfolio as live assets.

11. The method of claim 8, wherein the issuing of the security includes issuing a profit-making security to at least one investor based on an investment proportion set each investor, and the paying includes paying in cryptocurrency to a wallet of the investor based on the profit-making security issued for each investor among the profits generated from the asset.

12. The method of claim 11, wherein the paying includes paying in the cryptocurrency at a ratio corresponding to a number of NFTs stored in a wallet address owning the NFTs for each investor among the profits generated from the live asset.
